(19) United States
(12) Patent Application Publication
(10) Pub. No.: US 2013/0347025 A1
(43) Pub. Date: Dec. 26, 2013

(54) PROVIDING REMOTE ACCESS VIA A MOBILE DEVICE TO CONTENT SUBJECT TO A SUBSCRIPTION

(71) Applicants: Gyan Prakash, Beaverton, OR (US); Rajesh Poornachandran, Beaverton, OR (US); Kannan G. Raja, Beaverton, OR (US)

(72) Inventors: Gyan Prakash, Beaverton, OR (US); Rajesh Poornachandran, Beaverton, OR (US); Kannan G. Raja, Beaverton, OR (US)

(73) Assignee: Intel Corporation, Santa Clara, CA (US)

(21) Appl. No.: 13/996,007

(22) PCT Filed: Nov. 30, 2011
(86) PCT No.: PCT/US11/62712

§ 371 Date: Sep. 6, 2013

(51) Int. Cl. H04N 21/258

(52) U.S. Cl. CPC H04N 21/25875
USPC 725/25

(57) ABSTRACT

In one embodiment, the present invention includes a method for accessing content subscription information from a secure storage of a mobile device, communicating the content subscription information to an authorization service of a content provider with a request to receive content, receiving in the mobile device an authorization from the content provider which includes a time bound identifier corresponding to a time bounded authorization to receive the content during a time bounded window, and receiving and outputting the content from the mobile device during the time bounded window. Other embodiments are described and claimed.

### BACKGROUND

Adoption of mobile devices such as smartphones, tablets and so forth is growing exponentially, revolutionizing usage scenarios for media consumption both in corporate and end user segments. One such usage is multiscreen TV or TV everywhere, where a user can watch video content on personal devices such as a tablet computer or smartphone. The user demand for such services has been growing dramatically. However, platform security mechanisms that can support such usages are not readily available, thus restricting the availability of content.

### BRIEF DESCRIPTION OF THE DRAWINGS

FIG. 1 is a block diagram of a network in accordance with an embodiment of the present invention.

FIG. 2 is a flow diagram of a method in accordance with one embodiment of the present invention.

FIG. 3 is a flow diagram of a method in accordance with another embodiment of the present invention.

FIG. 4 is a block diagram of a network in accordance with another embodiment of the present invention.

FIG. 5 is a flow diagram of a method in accordance with one embodiment of the present invention.

FIG. 6 is a block diagram of a software architecture for a mobile platform in accordance with one embodiment of the present invention.

FIG. 7 is a block diagram of an example system in accordance with one embodiment of the present invention.

### DETAILED DESCRIPTION

Embodiments provide mechanisms to allow a user to carry content subscriptions such as TV subscriptions on multiple devices to enable the user to access content subject to such subscriptions at a variety of locations, and on different devices securely. For example, the user can watch TV content at any location, either within the home or away from home when traveling.

Embodiments also provide security mechanisms for platforms such as a set-top box (STB), cable box, cable card, digital video recorder (DVR) or other content gateway. As used herein, the terms “set-top box” or “STB” are used to generically refer to any type of end user content gateway that provides access to protected digital content to be rendered into audio and/or video. In this way, a multichannel video programming distributor (MVPD) vendor can enable time bounded device authentication for sharing content from the platform. In some usage models, the provider can charge additional fees for secure sharing of protected content for viewing purposes.

Accordingly, a user can consume media content on a trusted device or share with family members from a set-top/cable box according to a time bounded authentication mechanism. For example, if a user wants to temporarily watch the content available via a set-top/cable box located at the user's home on a remote device such as a tablet, then the user can add the tablet to a trusted device list for a specified period of time (e.g., hours, days or weeks). Note that in various implementations, the length of the time bounded permission and/or the number of permitted devices can be based on different payment based options. In turn, a security mechanism on a platform in accordance with an embodiment of the present invention allows the user to access the content based on security and fee-based policies.

In another scenario if a user is traveling and wants to watch his subscription content on a temporary basis via a hotel TV or other device, the user can add the device as a trusted device if security requirements are met. Accordingly, the user can watch subscribed media content on the trusted device based on time bounded security policies.

Although the scope of the present invention is not limited in this regard, embodiments can provide a firmware/software security mechanism on a variety of platforms including smartphones, tablets, ultrabooks, and so forth. In addition, a backend server such as of a MVPD can perform user identity and device authentication, in addition to digital rights management (DRM) mechanisms such as Digital Living Network Alliance (DLNA) and digital transmission content protection-Internet protocol (DTCP-IP) protocols. When authentication is confirmed, in that the user is identified and the device that is to access the content meets the security requirements of a given service provider, content can be accessed. For example, real time content sharing on a mobile device from a set-top box can occur in a manner in which the identified/authenticated device can share the content from the set-top/cable box. Although described herein as being shared for a STB or other content gateway of the user, understand that the scope of the present invention is not limited in this regard, and the sharing can be via, e.g., a cloud-based repository such as a content service of the MVPD vendor.

In various embodiments, time bound trust can be established between devices with a pay-for-use mode. For example, a user can use a trusted device to view content for four hours with payment of an appropriate fee to a MVPD vendor. Note that the user can add remote devices such as a TV in a hotel/friend's place as a trusted device for viewing content temporarily if security and location requirements are met. Accordingly, platform solutions based on firmware, secure device and authentication, and DRM via, e.g., a mobile platform, can be realized. In this way, a user can dynamically add personal devices as trusted devices for viewing protected content received from, e.g., a cable provider, if security requirements are met. In addition, a user can dynamically add a guest device as a trusted device based on time bounded authentication and device identification if security and location requirements are met.

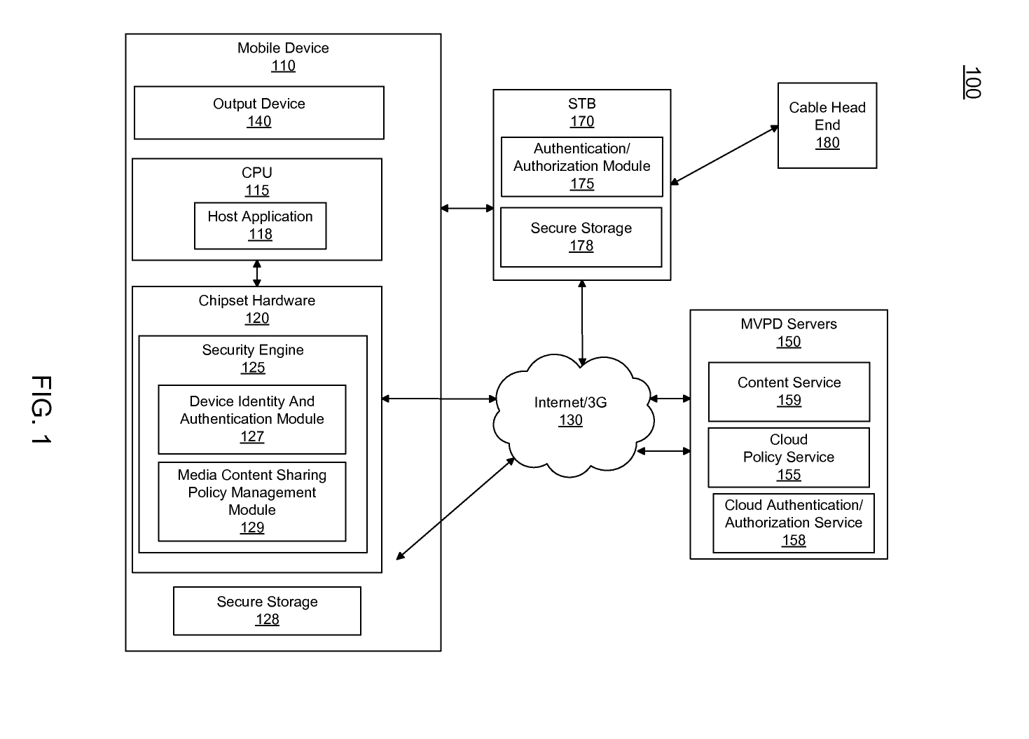

Referring now to FIG. 1, shown is a block diagram of a network in accordance with an embodiment of the present invention. As shown in FIG. 1, network 100 provides for interaction between a mobile device 110, one or more MVPD servers 150 and a set-top box 170. As seen, communication between these devices can be via various mechanisms including via a network 130 which can be an Internet-based network, a wireless-based network such as a third generation (3G) or fourth generation (4G) wireless communication network, or a local wireless network such as an Institute of Electrical and Electronics Engineers (IEEE) 802.11 protocol (e.g., WiFi™ network) or Bluetooth™ connection between mobile device 110 and set-top box 170. In addition, distribution of content to set-top box 170 can be via cable distribution from a head end 180, which may be of a cable provider, which in some embodiments can correspond to the MVPD provider.

As seen in FIG. 1, mobile device 110, which can be a smartphone, tablet computer, ultrabook or other portable computing device, can include a central processing unit (CPU) 115 that executes a host application 118. In various embodiments, this host application may be a downloaded application such as a remote content application to provide for remote access to subscription content, e.g., originally provided to set-top box 170.

Still referring to mobile device 110, CPU 115 can be coupled to a chipset hardware 120, e.g., via a secure path. Chipset hardware 120 can further include a security engine 125 which can be a collection of hardware, firmware and/or software to perform security operations in accordance with an embodiment of the present invention. In the embodiment shown in FIG. 1, security engine 125 can include a device identity and authentication module 127 (referred to herein as an IAM module) and a media content sharing policy management module 129 (referred to herein as a SPM module). In various embodiments, security engine 125 can provide a tamper proof secure execution environment independent of Host CPU 115. The security engine may provide hardware cryptographic accelerators to perform high intense cryptography operations efficiently and securely in hardware. Also, secure storage, which may be part of the security engine or associated therewith provides capability to store policies, keys for cryptographic operations, and so forth. Security mechanisms like public key cryptography/Advanced Encryption Standard (AES), etc. may be implementation specific, and can be chosen by content distributors that can be implemented via the HW support provided by security engine 125.

In one embodiment, IAM module 127 allows a user to request to add a device as a trusted device to a subscription such that the user can consume content on that device without any other user authentications. In one embodiment, the device identity and authentication data can be stored in a secure storage 128 managed by a trusted execution environment (of security engine 125) independent of a host operating system (OS) and CPU 115.

In one embodiment, SPM module 129 can be set by an authorized user on mobile device 110 during a device trust provisioning process such that only specific rated content can be displayed on this device. The policy can also be set such that content can only be displayed in specific geographic locations. These policies can be managed, in one embodiment, by a MVPD service provider. Examples of these policies include specified location(s) for sharing content, quality of the content (e.g., destination of the content, allowed play mode and so forth), additional security mechanisms for user/device authentications as indicated, such as monthly changes to passwords, e.g., a specific one-time programming (OTP) password to ensure the device is used by the authorized persons. In one embodiment, an OTP password can be sent either through e-mail or a cloud-based access web user interface mechanism. Other policies can include ratings allowed, adding devices on which content can be consumed, removing devices from which content can be consumed, additional authentication mechanisms, content viewing timing and so forth.

Still referring to FIG. 1, mobile device 110 can be in communication with an MVPD server 150, e.g., via the Internet. In various embodiments, one or more such servers can be present and associated with the MVPD provider. As an example, many such servers can be present, e.g., at a cloud-based location associated with the content provider to enable identification and authorization operations, as well as to perform policy management operations. Still further, additional servers present at this cloud-based location can perform content retrieval and delivery to a device indicated by the subscriber, as described herein.

To this end, as seen in the embodiment of FIG. 1 multiple services can be present. Note that these services can be executed on different hardware platforms such as different servers of the content provider at the cloud-based location or at another such location. For example, each of the three services shown in FIG. 1 can be executed on one or more servers, such that at least three such servers are coupled together to provide interaction between the services as described herein. In the embodiment shown in FIG. 1, server 150 can include a cloud policy service 155 which can be used to provide policy definitions with regard to remote access to subscription content by various subscribers. In turn, cloud policy service 155 can be in communication with a cloud authentication/authorization service 158. In various embodiments, service 158 can receive incoming requests from a user for remote access to subscription content and based on current information of the user and various information in cloud policy service 155, determine whether to provide authentication/authorization such that content subject to a subscription can be provided to, e.g., mobile device 110. As further seen in FIG. 1, additionally a content service 159 can be present. This content service can be associated with multiple data storage devices such as a storage area network that can store and retrieve content to be provided to subscribers.

In one embodiment, cloud authentication/authorization service 158 and cloud policy service 155 can be used by users to add a remote device over the cloud either from a TV that has Internet access, e.g., via a wired or wireless (e.g., WiFi™) interface, or by using a mobile device. The user can also manage multiple device policies on the cloud and can remove/add or change content viewing policies such as rating, adding new devices, removing new devices, additional authentication mechanisms and content viewing timings and so forth.

To enable subscription content to be provided to mobile device 110 assuming that authentication/authorization is successful, server(s) 150 can communicate with STB 170 to cause content stored in or associated with STB 170 (e.g., via a network attached storage (NAS)) to be provided, e.g., on a streaming basis to mobile device 110. As seen in the embodiment of FIG. 1, STB 170 can include an authentication/authorization module 175 which, responsive to information from MVPD server 150 and/or mobile device 110, can provide subscription content to be sent to mobile device 110. In some embodiments the content can be stored in a secure storage 178 of the STB. Although shown at this high level in the embodiment of FIG. 1, understand the scope of the present invention is not limited in this regard. For example, mobile device 110 can act as a proxy for another device such that after authentication/authorization via mobile device 110, the subscription content can be provided to another device, e.g., a hotel TV where the user (and the user's mobile device) is present.

In one embodiment, a user can add a new device by downloading a content viewing application on the device. To this end, the device can be provisioned with a new device identity based on available subscriptions of the user. In some embodiments, there may be additional fees to add a device based on a MVPD business model. During this initialization process, a unique identifier (ID) can be created based on a user subscription profile and stored in a secure storage of the mobile device. The user's authentication can be securely tied to a device login and secure boot process by relying on an OS and/or firmware and an application integrity check at boot time. The content accessed via this device can be protected with DRM support in firmware and/or software. The level of DRM support to be provided to allow content sharing, as well as content access policies to provide a given level of access, such as viewing versus storing, can depend on the security available on the platform and MVPD business model.

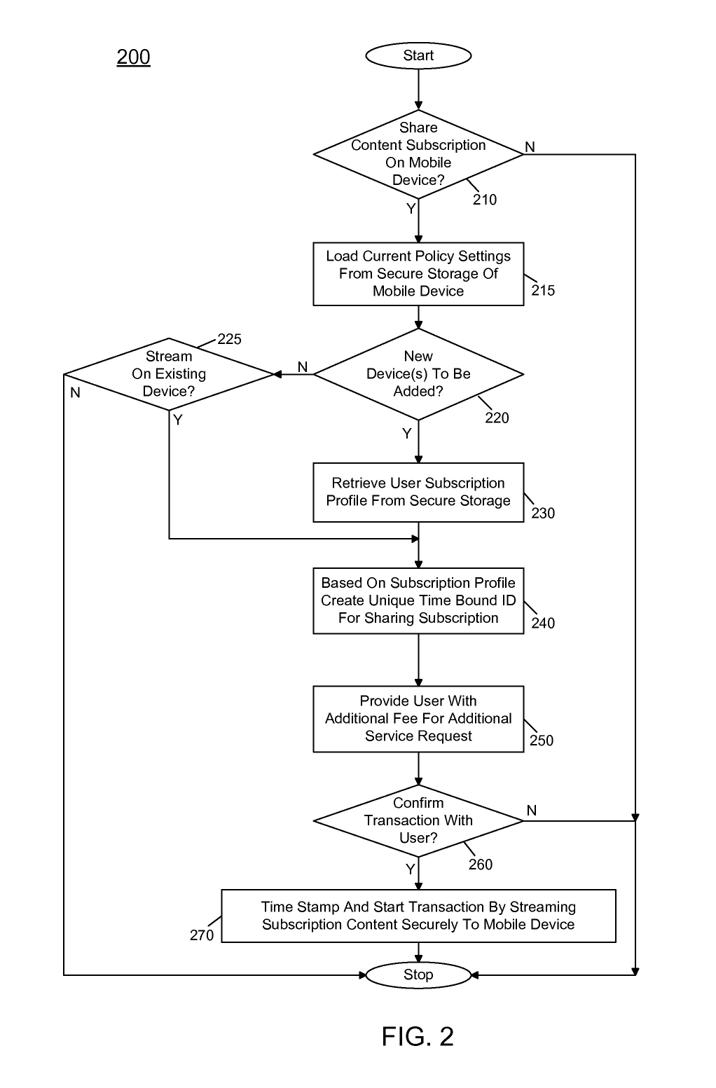

Referring now to FIG. 2, shown is a flow diagram of a method in accordance with one embodiment of the present invention. As shown in FIG. 2, method 200 can be implemented by a combination of a mobile device, a MVPD authorization server, and a content server, e.g., of the MVPD provider, which can provide for cloud-based access to subscription content. As seen in FIG. 2, method 200 may begin by determining whether it is desired to share a content subscription on a mobile device (diamond 210). Note that for purposes of illustration the embodiment described in FIG. 2 is with regard to a television subscription such as a cable subscription. However understand the scope of the present invention is not limited in this regard and embodiments apply to various types of content subscriptions such as audio, video, mixed media and so forth.

As further shown in FIG. 2, if a user desires to share a subscription with a mobile device, control passes to block 215 where current policy settings can be loaded from a secure storage of the mobile device. For example, a sharing policy module of the mobile device can load the current policy settings which may be present in a secure storage such as a non-volatile memory of the mobile device. Next it can be determined at diamond 220 if a new device is to be added such as a hotel room television, tablet or so forth. If so, control passes to block 230 where a user subscription profile can be retrieved from the secure storage. In one embodiment, a device identity and authentication module of the mobile device can retrieve this profile. In one embodiment, the subscription profile originates from a content provider (e.g., MVPD/cable service provider) with whom the user has a subscription binding contract. The provide may include subscription details of the user, e.g., sports package, news package, high definition (HD) package, etc. Note that profile(s) may be user/device specific, can be updated dynamically by the content provider. For example, a user may not be charged for non-high definition content viewed on mobile devices, but when the user watches the same content in HD on a TV, a fee could apply. The profile can then be communicated to a content supervisor such as an MVPD vendor, namely to an authorization server of the MVPD.

Still referring to FIG. 2, if instead at diamond 220 it is determined that a new device is not to be added, control passes to diamond 225 where it can be determined whether streaming on an existing device is to be performed. If so, control passes to block 240. Otherwise the method can conclude.

As seen, control next passes to block 240 where based on the subscription profile as communicated to a content supervisor, a unique time bound identifier can be created to enable sharing of subscription information. As discussed above, access can be provided in a time bounded manner and accordingly, the time bound ID may provide for information with regard to an identity of the device on which the authorization is granted as well as a duration of the time bounded authorization. In one embodiment, the information contained in the time bound ID is a unique identifier (to identify this authorized content sharing), expiry time of the ID, authorization to store content locally on a user's device/shared device with a specified period of time, or so forth. Via this time bound authorization, a user can download certain content to be stored locally on the device and can allow playback even when the network is not available (e.g., in-flight mode or when camping in a remote wilderness). In some embodiments, this information can include a simple time duration, e.g., four hours, eight hours, 24 hours or so forth. In other embodiments, the time bounded information can further provide specific viewing hours. For example, for a certain amount of time after new content is released, e.g., a broadcast television program, a new movie or so forth, different manners of time bounding can be performed. Further, different policies such as different fee level for accessing different types of content or at different times can be implemented. Note that block 240 can be performed in the MVPD server, in various embodiments. Note that storage of the time stamp may be an implementation choice. In one embodiment, it could be stored locally or in the cloud/remote, but note that time stamping is done in the secure execution environment. If maintained in the cloud, the mobile device can synchronize with the cloud periodically on the time stamp information. Depending on the network availability, or device limitation, cloud or local time stamping can be done.

Still referring to FIG. 2, at block 250 the user can be provided with information regarding any additional fee required for the service request. Thus at diamond 260 it can be determined whether the user has confirmed the transaction. If not, method 200 may terminate. Note that in some embodiments, this approval for additional fees can be optional and content can be provided with no further fees to the user, based on a particular subscription structuring and MVPD business model. In some embodiments this additional confirmation may be a “one-time” event and configurable so user is not prompted every single time that sharing is invoked. Note that additional fees can be paid instantly or can be billed to user along with subscription costs.

Assuming that the user confirms the transaction control passes to block 270 where a time stamp can be generated and the transaction can begin by streaming of the content securely to the mobile device. In the embodiment of FIG. 2, this secure communication of subscription content can be from a content server associated with the MVPD provider directly to the mobile device. As examples of the secure transmission, various DRM technologies such as a DLNA or DTCP-IP protocol may be implemented. Furthermore, understand that the transmission does not begin until a secure authentication with regard to the mobile device has been completed.

Although shown with this particular implementation in the embodiment of FIG. 2, understand the scope of the present invention is not limited in this regard. For example, instead of providing streaming content to the mobile device, the content can be provided in another manner such as secure download to a secure storage of the mobile device, from which the content can then be played. Still further, rather than receiving the content from a cloud-based location associated with a content provider, in other embodiments the requested content can be obtained from a set-top box associated with the user. To effect such operation, embodiments can further provide for communication between a cloud-based authentication mechanism, e.g., of an MVPD provider and the user's set-top box. In addition as will be discussed further below, rather than providing the content to the mobile device, it can be provided to another device, e.g., a device such as a hotel room TV to which a user has temporary access.

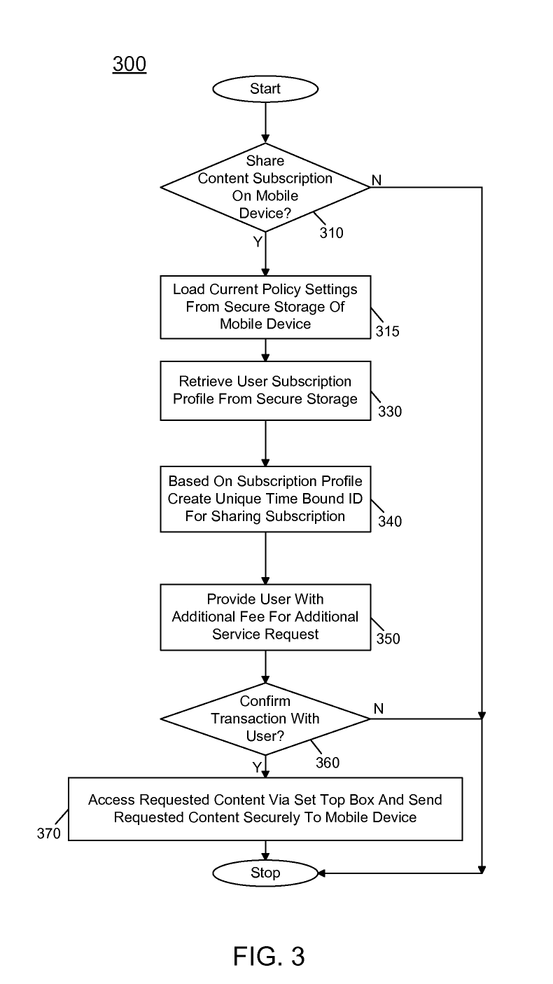

Referring now to FIG. 3, shown is a flow diagram of a method in accordance with another embodiment of the present invention. As shown in FIG. 3, method 300 can be implemented by a combination of a mobile device, a MVPD authorization server, and a STB of the user so that requested content can be provided from the user's own STB to the user's mobile device. In general, method 300 can be performed in similar manner to that discussed above with regard to method 200 of FIG. 2; however, communications occur between a cloud-based server of the MVPD provider and the user's set-top box to enable initiation of the content provision.

As seen in FIG. 3, method 300 may begin by determining whether it is desired to share a content subscription on a mobile device (diamond 310). If a user desires to share a subscription with the mobile device, control passes to block 315 where current policy settings can be loaded from a secure storage of the mobile device. Next at block 330 a user subscription profile can be retrieved from the secure storage. The profile can then be communicated to a content supervisor such as an authorization server of the MVPD.

Control next passes to block 340 where based on the subscription profile, a unique time bound identifier can be created to enable sharing of subscription content. As discussed above, access can be provided in a time bounded manner and accordingly, the time bound ID may provide for information with regard to an identity of the device on which the authorization is granted as well as a duration of the time bounded authorization. Note that block 340 can be performed in the MVPD server, in various embodiments.

Still referring to FIG. 3, at block 350 the user can be provided with information regarding any additional fee required for the service request. Thus at diamond 360 it can be determined whether the user has confirmed the transaction. If not, method 300 may terminate. Otherwise, assuming that the user confirms the transaction control passes to block 370. At block 370, requested content can be accessed via the user's set-top box and sent securely to the mobile device. To this end, the authentication server that generates the time-bounded authorization can provide this authorization information, e.g., both to the mobile device as well as the set-top box to enable the content delivery to occur. Note that the communication link between the set-top box and the mobile device can be realized in different manners. For example, when the mobile device is in a wireless local area network with the set-top box, this communication can be via a wireless connection between the devices. If instead the mobile device is remotely located from the set-top box, the communication can be via another network such as an Internet-based network and/or a wide area wireless network such as a cellular network. To this end, the information provided to the set-top box to enable the communication can include various identifiers of the mobile device to enable the communication to occur.

In various embodiments, the mobile device can further be used to access a program guide to identify content desired for storage into the STB, and to further program the STB to access and maintain the content. To provide for such programming, the mobile device can include, either in the same or separate user application, a control panel to enable recording of content on the set-top box. In this way the content can be stored in the set-top box responsive to a request to store the content communicated from the mobile device to the authentication service of the content provider (or directly to the STB).

Although shown with this particular implementation the embodiment of FIG. 3, understand that variations are possible. For example, in some embodiments it is possible for a user to bypass communications from the mobile device to the authentication server of the MVPD provider, and instead provide the user subscription profile directly to the user's set-top box, in embodiments in which the users set-top box includes an authentication mechanism capable of authenticating the mobile device and thus directly providing access to the requested content without the need for first receiving instruction from the authorization service of the provider.

As discussed above, it is possible for a user to also gain access to subscription content via a temporary device where the user is located. As used herein, the term “temporary device” is used to refer to a content output and/or rendering device such as a television, tablet computer or other device to which a user has a time-bounded access such as a hotel room TV. To this end, this temporary device, which can be an Internet-connected TV, can itself seek authorization to receive the subscription content. At the least, the connected device can include identification information to enable receipt of the subscription content from a network such as the Internet responsive to an authorization for the temporary device performed independently of the device itself.

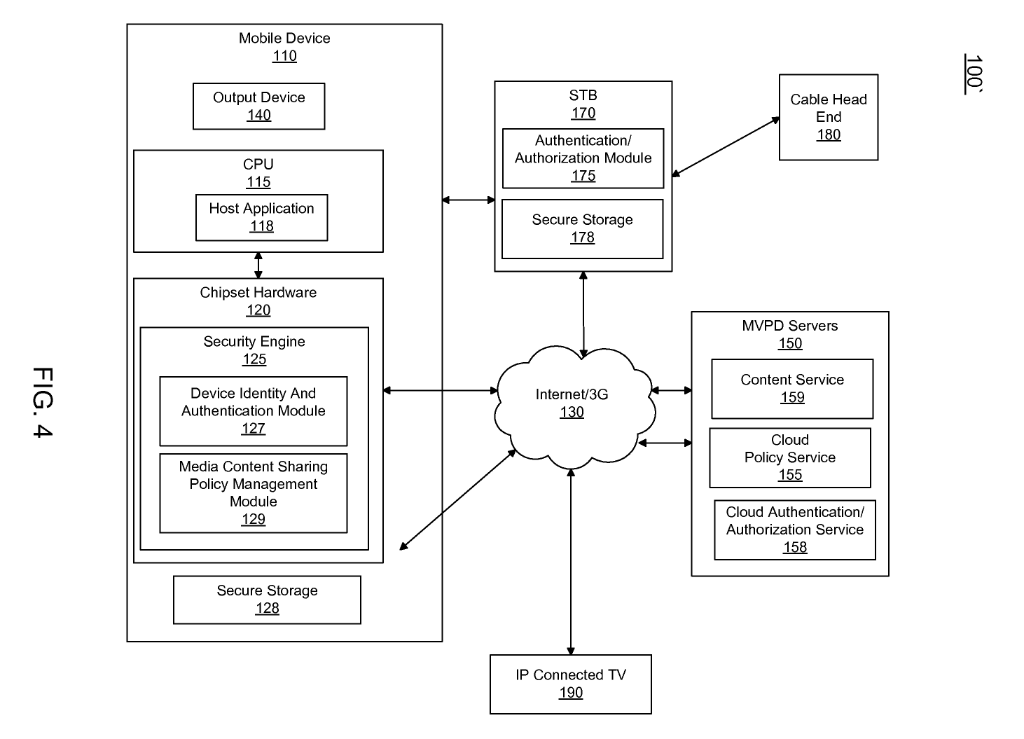

Referring now to FIG. 4, shown is a block diagram of a network in accordance with another embodiment of the present invention. As seen in FIG. 4, network 100′ generally is configured the same as network 100 of FIG. 1. However note that in FIG. 4, an additional device, namely an Internet protocol-connected TV 190 is present. In different implementations, content subject to a subscription can be provided to this device from the users mobile device 110, via the users set-top box 170 or in another manner, such as via content service 159 associated with an MVPD provider. In other aspects, network 100′ may be configured as in FIG. 1.

Using a network-connected temporary device such as present in the FIG. 4 network, embodiments can enable subscription content to be provided in a time-bounded manner to the temporary device. This time-bounded authorization can be, for example, coextensive with a length of stay of the user in a location of the temporary device. For example, assume a user has a week-long stay in a hotel room, the authorization can be arranged in a time-bounded manner to enable the user to access subscription content during this weeklong stay on the temporary device, without further authorizations. Of course different time periods of the authorization can occur in different embodiments.

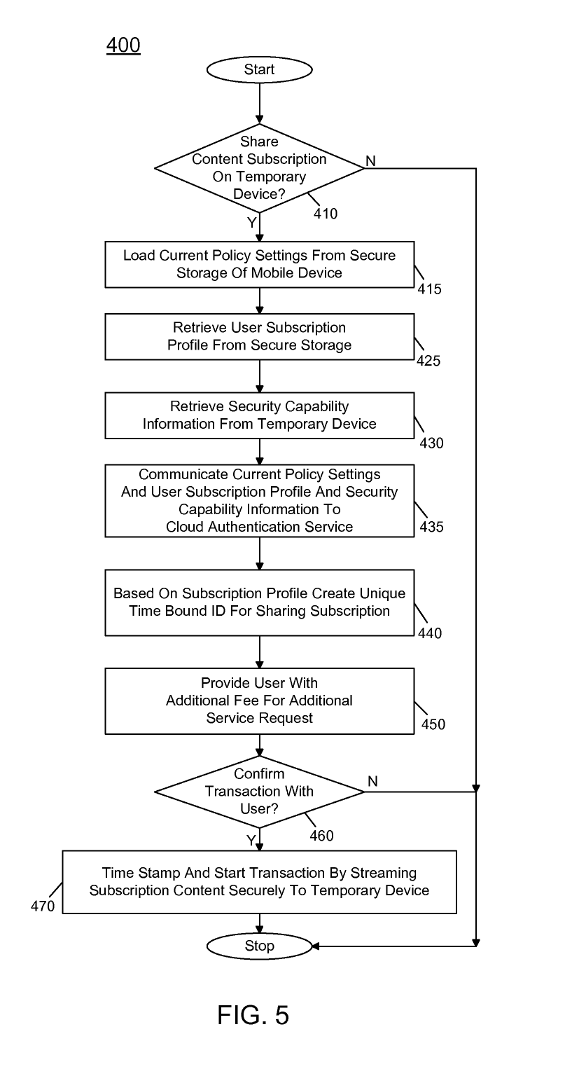

Referring now to FIG. 5, shown is a flow diagram of a method in accordance with one embodiment of the present invention. As shown in FIG. 5, method 400 can be implemented by a combination of a mobile device, a MVPD authorization server, and a temporary device to which the user has access. As seen in FIG. 5, method 400 may begin by determining whether it is desired to share a content subscription on a temporary device (diamond 410). As further shown in FIG. 5, if a user desires to share a subscription with a temporary device, control passes to block 415 where current policy settings can be loaded from a secure storage of the mobile device. Next control passes to block 425 where a user subscription profile can be retrieved from the secure storage. Then at block 430, security capability information can be retrieved from the temporary device. The current policy settings and user subscription profile can be sent from the mobile device itself. In different implementations, the mobile device can be a smartphone, tablet or other portable device as discussed above, or it can be a smart card that includes this information. In either case, a communication of this information along with the security capability information of the temporary device can be collected and provided to the MVPD provider. This communication can be from the mobile device, from the temporary device, or combinations of both in instances where both have a communication mechanism to reach the content provider. Thus the current policy settings, the user subscription profile, and the security capability information can be communicated, e.g., to a cloud authentication service (block 435).

As seen, control next passes to block 440 where based on the subscription profile, a unique time bound identifier can be created to enable sharing of subscription information. Of course, this assumes that both the user and the temporary device are authenticated in that the user has a valid subscription profile and furthermore, that the security configuration information indicates that suitable secure mechanisms are present in the temporary device to protect received content per the content provider's policies. This time bound identifier thus may provide for access in a time-bounded manner and accordingly, the time bound ID may provide for information with regard to an identity of the temporary device on which the authorization is granted as well as a duration of the time bounded authorization.

Still referring to FIG. 5, at block 450 the user can be provided with information regarding any additional fee required for the service request. Thus at diamond 460 it can be determined whether the user has confirmed the transaction. If not, method 400 may terminate. Otherwise, assuming that the user confirms the transaction control passes to block 470 where a time stamp can be generated and the transaction can begin by streaming of the content securely to the temporary device. In different implementations, this communication of subscription content can be from a content server of an MVPD, from the users set-top box or from another location, e.g., directly from a cable head end of a service provider. Although described at this high-level in the embodiment of FIG. 5, understand the scope of the present invention is not limited in this regard.

Embodiments thus allow time bounded content sharing in a secure manner to one or more devices, e.g., mobile devices remote to a primary platform, e.g., a set-top box. A cloud-based configuration capability can be used to add/remove devices dynamically, enable/disable specific rated contents on specific devices, and so forth. By providing a hardware-based secure authentication, content execution transfer across devices is limited.

Real time content sharing on an authenticated mobile device from a set-top box is controlled such that only having a given DRM mechanism such as DLNA and DTCP-IP protection is not sufficient. Instead the device is authenticated to meet security requirements, e.g., of a service provider, such that only trusted/paid devices can share the content from a set-top/cable box or other content source. Access by such trusted devices can be time bounded so that the device can only view content for a predetermined duration, and may further be subject to a fee or business based mechanism of a MVPD vendor.

Note that the subscription profile information stored on the mobile device can be updated and also maintained on other devices. For example, to maintain coherency of the subscription profile information across various compute platforms, the user subscription profile information and updates to it can be stored at a cloud-based location such as at a cloud-based location of the content provider. In this way, the cloud-based storage of the subscription profile information can remain the central point for coherency such that when the user seeks to access the subscription profile information with a remote device, an indication of update availability can be provided so that the user can access the updated user profile information from the cloud-based storage.

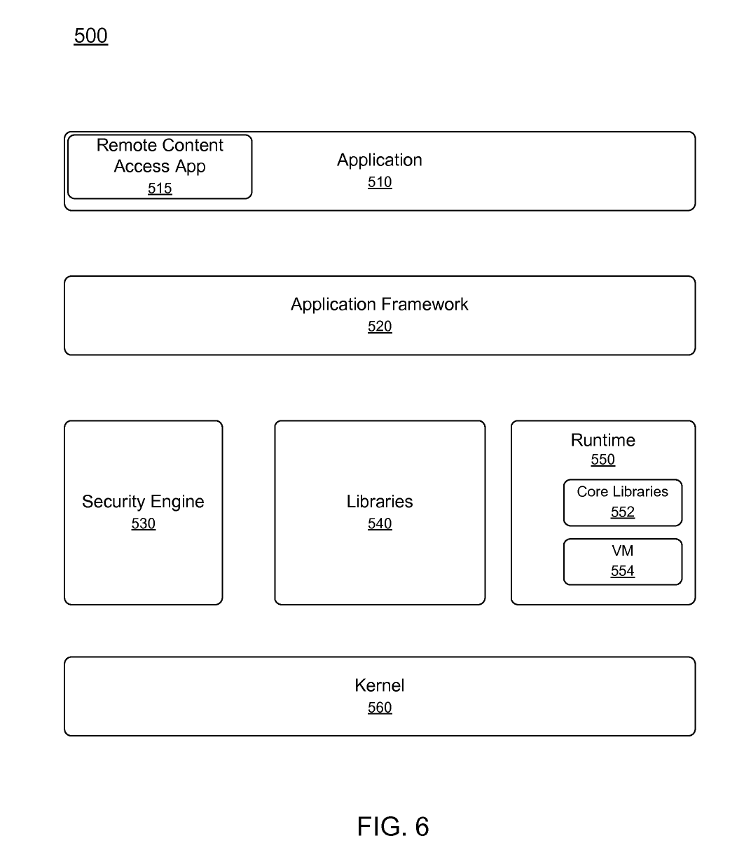

Embodiments can be implemented in many different systems. For purposes of illustration, a security engine within the context of a smartphone, namely an Android™-based smartphone is shown in FIG. 6. Note that this smartphone is not the primary device at which a user receives the subscription content. As seen, FIG. 6 shows a block diagram of a software architecture 500 for an Android™-based platform. As seen, architecture 500 includes an application layer 510 in which various user applications can execute. One such application may be a remote content access application 515 which may be configured in accordance with an embodiment of the present invention to enable a user to access subscription content via the smartphone. Application 515 can be downloaded to the smartphone, e.g., via an application store provided by a service provider. Various other user applications, ranging from communications applications, computing applications, e-mail applications and so forth, may further reside in application layer 510.

An application framework 520 executes below application layer 510. Application framework 520 may include various managers to manage functionality of the smartphone. In turn, various services, agents, native libraries and a runtime can execute below application framework 520. In the embodiment shown in FIG. 6, such components may include a security engine 530 on which an identification/authorization module and a sharing policy module can execute. These modules may provide strong security protection such that a content provider is willing to allow content to be provided to the smartphone, subject to the above-described authentication/authorization process. Security engine 530 may further be configured with one or more DRM technologies to allow streaming of protected content but prevent storage of the content in a non-volatile storage of the smartphone. The security engine can further prevent output of the content outside of a permitted time bounded window. In addition, various native libraries 540 may be present to handle different services. In addition, a runtime 550 can include core libraries 552 and a process virtual machine (VM) 554 such as a Dalvik VM. As further seen in FIG. 6, all of the above components can execute on a kernel 560, namely a Linux™ kernel. Such kernel can include various drivers for hardware interaction, networking interaction and so forth.

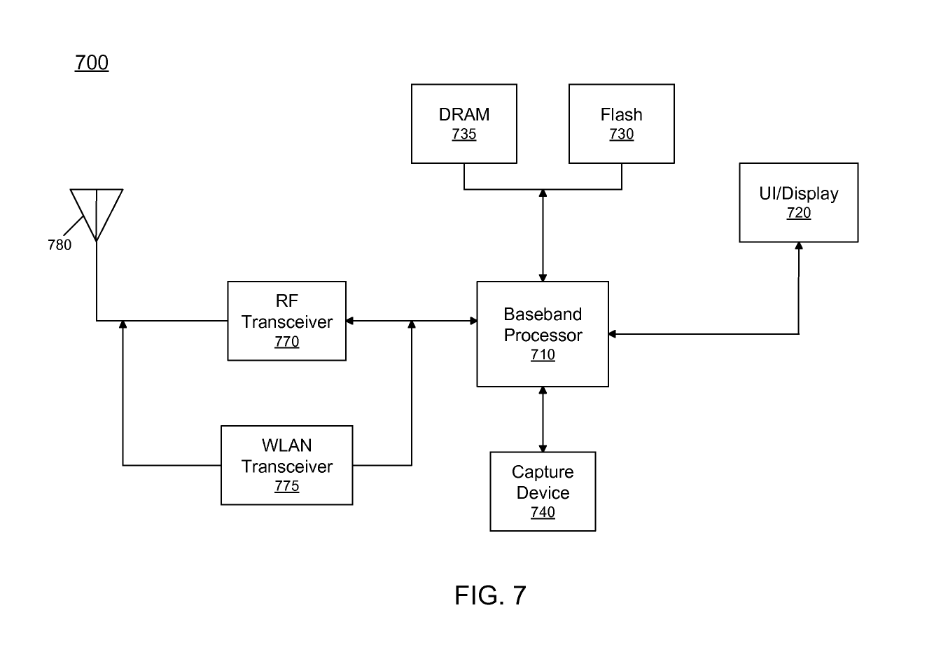

Embodiments thus can be used in many different environments. Referring now to FIG. 7, shown is a block diagram of an example system 700 with which embodiments can be used. As seen, system 700 may be a smartphone or other wireless communicator. As shown in the block diagram of FIG. 7, system 700 may include a baseband processor 710 on which a remote content sharing application can execute. In general, baseband processor 710 can perform various signal processing with regard to communications, as well as perform computing operations for the device. In turn, baseband processor 710 can couple to a user interface/display 720 which can be realized, in some embodiments by a touch screen display. In addition, baseband processor 710 may couple to a memory system including, in the embodiment of FIG. 7 a non-volatile memory, namely a flash memory 730 and a system memory, namely a dynamic random access memory (DRAM) 735. As further seen, baseband processor 710 can further couple to a capture device 740 such as an image capture device that can record video and/or still images.

To enable communications to be transmitted and received, various circuitry may be coupled between baseband processor 710 and an antenna 780. Specifically, a radio frequency (RF) transceiver 770 and a wireless local area network (WLAN) transceiver 775 may be present. In general, RF transceiver 770 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. Other wireless communications such as receipt or transmission of radio signals, e.g., AM/FM, or global positioning satellite (GPS) signals may also be provided. In addition, via WLAN transceiver 775, local wireless signals, such as according to a Bluetooth™ standard or an IEEE 802.11 standard such as IEEE 802.11a/b/g/n can also be realized. Although shown at this high level in the embodiment of FIG. 7, understand the scope of the present invention is not limited in this regard.

In one embodiment, servers of a content provider at a cloud-based location can perform authentications, policy management and content providing. To this end, the servers can include multiple independent servers, each to perform one or more services such as described above with regard to FIG. 1.

In one such embodiment, a first server can be configured to perform authentication and authorization operations responsive to identification information received from a mobile device of a subscriber, where this identification information is received with a request to receive content subject to a content subscription at a device remote from a principal residence associated with the content subscription.

In turn, a second server can be coupled to the first server to perform policy operations responsive to a communication from the mobile device. Such policy operations can include access and update to policy information associated with the content subscription, including association of alternate content devices with the content subscription. Another server can be coupled to the first and second servers to provide the content subject to the content subscription to the remote device responsive to authorization by the first server. This content provision can be based at least in part on the policy information and the identification information. More specifically, the policy information for the subscription indicates that the remote device is an alternate content device associated with the subscription. As an example, the remote device can be the mobile device of the subscriber, or it can be another device, such as a device to which the subscriber has temporary access (and assuming that this device has an acceptable level of security).

Embodiments may be implemented in code and may be stored on at least one non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
accessing content subscription information from a secure storage of a mobile device, the content subscription information associated with a content subscription of a user of the mobile device;
communicating the content subscription information from the mobile device to an authorization service of a content provider with a request to receive content subject to the content subscription;
receiving in the mobile device an authorization from the content provider, the authorization including a time bound identifier corresponding to a time bounded authorization to receive the content during a time bounded window; and
receiving the content and outputting the content via an output device associated with the mobile device during the time bounded window.

2. The method of claim 1, further comprising receiving the content from a set-top box associated with the user of the mobile device.

3. The method of claim 2, further comprising storing the content in the set-top box during a broadcast of the content prior to the time bounded window.

4. The method of claim 3, further comprising storing the content in the set-top box responsive to a request to store the content communicated from the mobile device to the set-top box.

5. The method of claim 1, wherein the content provider is a multichannel video programming distributor.

6. The method of claim 1, wherein the mobile device is a smartcard including the content subscription information.

7. The method of claim 1, wherein the output device associated with the mobile device is a connected television remote to a home of the user of the mobile device.

8. At least one computer accessible medium including instructions that when executed cause a system to:
receive identification information in an authorization service of a content provider for a content output device present at a location at which a subscriber having a content subscription with the content provider is temporarily located;
receive user profile information associated with the subscriber from a mobile device to seek authorization to output content subject to the content subscription from the content output device for a time bounded duration; and
responsive to authorization of the content output device by the system, enable communication of the content to the content output device so that the content can be output via the content output device during the time bounded duration.

9. The at least one computer accessible medium of claim 8, further comprising instructions to enable the system to communicate the content from a content service of the content provider to the content output device, wherein the content output device is separate from the mobile device.

10. The at least one computer accessible medium of claim 8, further comprising instructions to enable the system to receive the identification information with the user profile information, wherein the user profile information is maintained on a smartcard.

11. The at least one computer accessible medium of claim 8, further comprising instructions to enable the system to receive a request from the mobile device to record a content broadcast at a predetermined time on a set-top box of the subscriber located remotely from the subscriber.

12. The at least one computer accessible medium of claim 11, further comprising instructions to enable the system to communicate the request to the set-top box to enable the recording of the content broadcast after authentication of the mobile device and the request via the authorization service.

13. The at least one computer accessible medium of claim 11, further comprising instructions to enable the system to, after the content broadcast is recorded, receive a second request from the mobile device to cause the recorded content broadcast to be communicated from the set-top box to the content output device.

14. An apparatus comprising:
a processor to execute instructions;
a security engine implemented in hardware of the apparatus, the security engine including an authorization module to enable a user to request content subject to a subscription of the user via an authorization service of a content provider, and a sharing policy module to enable the user to designate at least one other device to receive the content subject to the subscription;
a secure storage to store a user subscription profile; and
an output device to output content received in the apparatus subject to the subscription, wherein the apparatus comprises a mobile device that is not a primary device for receiving the content and wherein the mobile device is permitted to output the content for a time bounded duration based on an authorization received from the authorization service of the content provider.

15. The apparatus of claim 14, wherein the apparatus is to receive the content from a set-top box associated with the user.

16. The apparatus of claim 15, wherein the apparatus is to send a request to record a content broadcast at a predetermined time on the set-top box, wherein the set-top box is located remotely from the user.

17. The apparatus of claim 16, wherein the apparatus is to communicate a second request to the set-top box to receive a communication of the recorded content broadcast from the set-top box.

18. The apparatus of claim 14, wherein the security engine is to enable the output device to stream the content and to prevent storage of the content in a non-volatile storage of the mobile device.

19. The apparatus of claim 14, wherein the security engine is to prevent output of the content via the output device outside the time bounded duration.

20. A system comprising:
a first server to perform authentication and authorization operations responsive to identification information received from a mobile device of a subscriber of a content provider having a content subscription, wherein the identification information is received with a request to receive content subject to the content subscription at a device remote from a principal residence associated with the content subscription;
a second server coupled to the first server to perform policy operations responsive to a communication from the mobile device, wherein the policy operations include access and update to policy information associated with the content subscription, including association of alternate content devices with the content subscription; and
a third server coupled to the first and second servers to provide the content subject to the content subscription to the remote device responsive to authorization by the first server based at least in part on the policy information and the identification information, wherein the policy information indicates that the remote device is an alternate content device associated with the content subscription.

21. The system of claim 20, wherein the first, second, and third servers are at a cloud-based location associated with the content provider.

22. The system of claim 20, wherein the first server is to enable a set-top box associated with the subscriber to communicate requested content to the mobile device responsive to authorization of the mobile device.

23. The system of claim 20, wherein the first server is to receive a second request from the mobile device to record a content broadcast at a predetermined time on a set-top box associated with the subscriber and communicate the second request to the set-top box to enable the recording of the content broadcast after authentication of the mobile device and the second request.

24. The system of claim 20, wherein the remote device is separate from the mobile device, and wherein the identification information includes security attribute information of the remote device, and the authentication of the remote device is further based on the security attribute information, and the provision of the content to the remote device is limited to a time bound duration.

25. (canceled)

26. (canceled)
